(19) United States
(12) Patent Application Publication
(10) Pub. No.: US 2006/0111961 A1
(43) Pub. Date: May 25, 2006

(54) Passive consumer survey system and method

(76) Inventor: James McQuivey, Needham, MA (US)

Correspondence Address: LAW OFFICE OF BRETT N. DORNY, 386 WEST MAIN STREET, SUITE 12A, NORTHBOROUGH, MA, 01532, US

(21) Appl. No.: 10/995,068

(22) Filed: Nov. 22, 2004

(51) Int. Cl. G06F 17/30

(52) U.S. Cl. 705/10

(57) ABSTRACT

A passive tracking system and method are disclosed which use RFID tags carried by participants. RFID readers are positioned at the entrances to stores which are part of the study or analysis. Data relating to the visits of participants of the stores are recorded in a participant database. The data is used for consumer research and analysis.

### BACKGROUND OF THE INVENTION

1. Field of the Invention

The present invention relates to survey systems and processes. More particularly, it relates to a system for passive surveying of the shopping activities of participants.

2. Discussion of Related Art

Consumer research is a growing industry. The most common process for conducting research is a survey, in which participants are asked a series of questions relating to purchase decisions or activities. Such techniques can be problematic for obtaining accurate information. The survey process can be time consuming in order to collect the demographic information necessary to provide meaningful results from the survey analysis. Thus, busy shoppers are often unwilling to participate in such surveys.

The survey may also be conducted at a time other than when a purchase has been recently made. Surveys may ask participants about buying habits and purchase decisions, either past or future. However, the answers are often biased by the previously made decision or voided by a variation in future behavior. Furthermore, when a survey is conducted after a purchase has been made, participants have a need to justify their decision, which can alter a true understanding of the decision process. Survey techniques which monitor decisions as they are made can provide the best source of reliable data.

Technology has provided the capability for improved survey techniques. For example, nearly 10 years ago, New York-based Jupiter Media Metrix Inc. realized that software could track a consumer's Internet behavior continuously and effortlessly. Participants agree to be part of the process. They provide the necessary demographic information at a time convenient to them. The information is stored and later used with data to analyze the activities of the participants. Every day more than 50 million Internet users worldwide are being tracked—with permission—for commercial purposes. Nielsen NetRatings, a Media Metrix competitor, will sell nearly $50 million worth of that anonymous data in 2004.

Another example is the Portable People Meter (PPM) being tested by a joint venture between New York-based companies Arbitron and Nielsen Media Research Inc. The PPM is a pager-like device that clips to the belts of panelists. The device “listens” to its environment and takes note of special signals inserted into the audio channels of radio and television broadcasts. The PPM records the time and duration a particular signal is heard, and when it is returned to its charger base each night, it transmits that data to the Arbitron system. The data is then used to determine the precise activities of participants.

Similarly, Forrester Research recently unveiled its Ultimate Consumer Panel, a panel of 10,000 consumers nationwide that tracks many passive consumer data streams. Ultimate receives permission from its panelists to electronically and anonymously track monthly credit card statements, checking account statements, and wireless and residential phone bills in addition to monitoring its panelists' online behavior. Add to this the ability to survey its members and Forrester's Ultimate Consumer Panel can determine things that were previously impossible to track reliably.

These tracking mechanisms provide researchers with significant information regarding the habits of various types of consumers. It tracks the shopping habits of online users as well as the purchasing habits of those users. While extremely valuable for online stores and web companies, it is much less significant to traditional brick and mortar stores. Furthermore, while purchasing habits, identified from purchases, are helpful in theorizing on the bases of consumer purchase decisions, they do not reflect the true shopping activities of the purchasers. They do not represent the stores visited prior to purchases, comparisons which have been made, nor the other purchases foregone by the consumer.

Additionally, the shopping mall has continued to grow as the major location of consumer spending. Passive analysis of consumer spending through credit cards and checking accounts fails to provide information relating to much of the shopping mall experience. It does not account for visited stores in which no purchases are made. The layout and positioning of stores may affect the traffic and sales. Cash sales, often occurring in the food court or at carts in the center of the mall, are not reflected in the collected data. These activities may affect the purchase activities of consumers.

### SUMMARY OF THE INVENTION

The present invention provides a passive system for collecting shopping information relating to participants for purposes of consumer research and analysis. It tracks the activities of the participants regardless of whether a purchase was made. It can be used to understand traffic patterns for shoppers which result from the relative positioning of stores, either within a mall or in a larger area. It may also be used to determine traffic patterns in a single store.

The tracking system of the present invention uses an RFID tag carried by participants to track their activities. RFID readers are positioned at various locations of interest. Such locations include the entrances to stores. They may also include various parts of stores for tracking the shopping patters of persons within a store. When a participant passes by an RFID reader, the time and location are recorded by the tracking system. The stored times and locations can be analyzed to determine the time spent in stores, or parts of a store, and the order in which various stores were visited. The information collected for all participants can be used for research or analysis of consumer shopping patterns.

According to another aspect of the invention, participants must be registered in the system and provided with an RFID tag. Demographic information regarding the participants is collected when they are registered in the system. The demographic information is stored in the tracking system and can be used for analysis of consumer shopping patterns.

According to another aspect, the invention includes method for collecting and analyzing data related to movement of participants. Times at which participants are near certain locations are determined and recorded. The times may be determined by providing the participants with RFID tags and positioning RFID readers at the locations. Demographic information may also be stored and used in analyzing participant movement.

### BRIEF DESCRIPTION OF THE DRAWINGS

FIG. 1 is a block diagram of a consumer tracking system according to an embodiment of the present invention.

FIG. 2 illustrates RFID reader placement according to an embodiment of the present invention.

FIG. 3 illustrates tracking data according to an embodiment of the present invention.

### DETAILED DESCRIPTION

The present invention provides a system and method for passive monitoring of participant movements. It relates generally to the context of consumer research and analysis, but could be applied to other analyses as well. Specifically, a group of participants who are willing to participate in the monitoring program are registered. Demographic information is collected and stored with respect to these participants. Personal information may also be collected and stored, particularly if the participants are to be compensated for their participation. Alternatively, in order to maintain privacy, personal identifying information may not be collected, or may be separated from the demographic information and tracking information. Each participant is provided with an RFID tag. The RFID tag identifies the participant. RFID readers are located at locations of interest, such as at the entrance to stores. When a participant passes by the RFID reader, the RFID tag is read. Data relating to the time and location of the participant are recorded. The recorded information for all participants is analyzed to determine shopping patterns or other desired research.

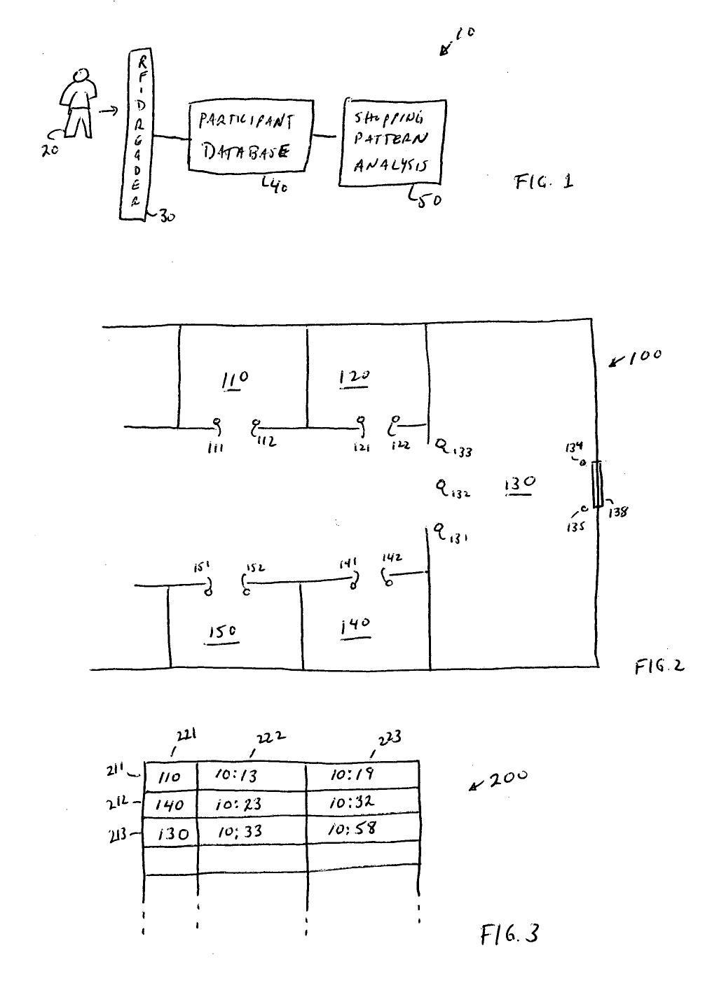

FIG. 1 illustrates the elements of a system 10 for passive tracking of participants according to an embodiment of the present invention. Each participant 20 carries an RFID tag (not shown). The RFID tag preferably is in a form easily carried by the user, such as a card or key ring. It may be inserted in or attached to another item regularly carried by the user. For example, RFID tags may be inserted into watches or cellular telephones. They may be inserted into a purse or wallet.

RFID readers 30 are placed in desired locations. The RFID readers may be of any type. Many stores have RFID readers at the exits for control of merchandise. The same readers can be used in conjunction with the survey system of the present invention. Additional RFID readers may be used in stores which do not currently utilize them. Furthermore, the additional RFID readers may also be used for merchandise control.

As is known in the art, the RFID readers are connected to a computer (not shown). The computer receives information from the RFID reader with respect to the read tags. The computer may be located in the store where the RFID reader is located, or may be at another location. Preferably, since the tracking system incorporates many different stores, the computer would be at a remote location. The RFID readers 30 may be directly wired to the computer, or may communicate wirelessly, or periodically thorough telephone lines or some other network. A plurality of computers may be used for collecting and aggregating data from the RFID readers 30. A plurality of first computers may be located near each RFID reader or within a single store. The first computers connect to a second computer for aggregating data from each of the first computers. The connections between the first computers and the second computer may be wired, wireless or through a network. Furthermore, any type of computer or simple processor can be used in connection with the system 10 of the present invention. The computer need only have the memory and processing capability to perform the functions of receiving and aggregating information from the plurality of RFID readers 30.

Independent of the computer hardware and structures which are utilized, the system 10 of the present invention collects the information from the RFID readers 30 into a participant database 40. The participant database 40 may be stored on any computer within the system having sufficient memory and processing capacity. The participant database 40 stores all of the information relating to participant movements which can be used for research and analysis. In particular, the participant database 40 stores, for each participant, the location and time for each input from the RFID readers 30. The information can be associated with the correct participant through use of the identifying information read from the RFID tag. Additionally, the participant database 40 includes demographic information for each participant. Such demographic information could include age, sex, marital status, race, economic status, educational attainment. Any other demographic information of interest may also be collected. The demographic information is collected upon registration of the participants. Personal information may also be collected and stored in the participant database 40. Personal information may be necessary to verify the integrity of the survey and analysis. It may also be necessary in order to compensate the participants, if required. On the other hand, personal information may be separated from the participant database 40 in order to preserve the privacy of the participants. The database or databases may be stored in one or memories of one or more computers.

Other information may also be collected and stored in the participant database. For example, it is known to track electronic information about participants, including credit card activity, checking account activity, online activity, etc. This information may also be collected and stored in the participant database 40 for use during analysis. Alternatively, such information may be stored in other databases and combined with the information from the participant database 40 during analysis.

The present invention is used for analyzing shopping patterns. The information from the participant database 40 is used in performing the analysis. Thus, the system 10 includes a shopping pattern analysis section 50. The shopping pattern analysis 50 may be performed in the same computer which stores the participant database 40. Alternatively, information may be transferred from the participant database 40 for the shopping pattern analysis. The nature of the analysis will depend upon the characteristics of interest to the researcher. The data in the participant database 40 may be used for different types of analyses.

FIG. 2 illustrates placement of RFID readers 30 in accordance with an embodiment of the present invention. FIG. 2 is a partial floor plan of stores 110, 120, 130, 140, 150 in a mall 100. RFID readers 111, 112 are positioned at the entrance or exit of the store 110. FIG. 2 illustrates two RFID readers at each entrance positioned so that shoppers will pass between them. The number and position of the RFID readers depends upon the type of RFID readers which are used. The same type of RFID reader does not need to be used in every store. For large entrances, such as in store 130, more than two RFID readers 131, 132, 133 may be required to ensure proper reading of RFID tags. Additionally, RFID readers 134, 135 are positioned at an external entrance 138 of store 130.

FIG. 2 is merely illustrative of an application of the tracking system 10 of the present invention. The tracking system 10 may be used to track shopping patterns for stores within a town, rather than just within a mall. With such an application, RFID readers 30 would be positioned at each of the entrances of the stores in the town, or of the stores to which the system is to be applied. Alternatively, the system may be used to track shoppers within a single store. For example, RFID readers may be positioned at the aisles of a supermarket to track shopping patterns within the store. The system can also accommodate combinations of these applications. The RFID readers may be positioned at locations other than store entrances. The positioning of the RFID readers depends upon the desired data for analysis.

Independent of the application for the system 10, the same data is recorded for future analysis. FIG. 3 illustrates the collected data in the form of a table 200. The table 200 corresponds to a single participant. Of course, the data may be stored in other formats. The table 200 has a plurality of rows 211, 212, 213 corresponding to readings from the RFID readers 30. For each row, three datum are recorded: the store 221 (or other location), the entry time 222 and the exit time 223. For some stores, such as store 110 in FIG. 2, the entry time 222 and exit time 223 are recorded by the same RFID reader. For other stores, such as store 103, participants may enter or exit through different locations. However, the system can determine and store the proper time independent of the particular entrance or exit used.

The store and time information in the participant database 40 can be used in performing an analysis of shopping patterns. Using this data, the stores which are visited, the order in which they are visited, the time within stores and the time between stores may be determined for multiple participants. Such information can be used for improving traffic patterns to control flow or to improve sales.

The present invention has been described with respect to use of RFID tags and readers for locating the participants. Other mechanisms may now be available or may be developed for locating participants as they enter or exit stores or other locations. For example, facial recognition systems may be used to locate participants. With such a system, cameras are placed at locations of interest, similar to the positioning of RFID readers. Existing security cameras could be used for such purposes. A camera would retrieve an image of a customer. The image is compared, using facial recognition technology, to determine the identity of the participant.

Alternatively, GPS technology can be used to determine the location of participants. Rather than a RFID tag, each participant may have a GSP device for determining position. The participant's position can be transmitted, for example, using wireless communications, to the system. The position can be used to determine location.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A system for collection of shopper traffic comprising:
a plurality of identification devices, each device being associated with one of a plurality of participants;
a plurality of readers, each reader determining the presence of one of the plurality of identification devices near the reader; and
a traffic database connected to the plurality of readers storing times at which identification devices are determined to be near readers.

2. The system for collection of shopper traffic according to claim 1, further comprising:
a demographic database of demographic information relating to the plurality of participants; and
an analysis system for analyzing traffic patterns of participants based upon data in the traffic database and demographic database.

3. The system for collection of shopper traffic according to claim 1, wherein the identification devices include RFID tags, and wherein the plurality of readers includes a plurality of RFID readers.

4. The system for collection of shopper traffic according to claim 1, wherein at least one of the readers is positioned at an entrance to a store.

5. The system for collection of shopper traffic according to claim 1, wherein the plurality of readers are positioned at locations within a single store.

6. The system for collection of shopper traffic according to claim 1, wherein the plurality of readers are positioned at locations within a mall.

7. The system for collection of shopper traffic according to claim 1, wherein the plurality of readers includes readers positioned at the locations of ingress and egress to a predetermined area; and wherein the system further includes means for determining the duration of participants within the participant based upon times stored in the traffic database.

8. A method for collection of shopper traffic data comprising the steps of:
determining times at which participants are near predetermined locations; and
recording the determined times.

9. The method for collection of shopper traffic data according to claim 8, wherein the determining step includes the steps of:
providing each of a plurality of participants with an identification device;
positioning a plurality of readers at the predetermined locations; and
determining when an identification device is near a reader.

10. The method for collection of shopper traffic data according to claim 9, wherein the identification device includes an RFID tag and wherein the plurality of readers includes a plurality of RFID readers.

11. The method for collection of shopper traffic data according to claim 8, further comprising the step of collecting demographic information for a plurality of participants.

12. A method for analyzing movements of a plurality of participants, the method comprising the steps of:
determining the presence of the plurality of participants at a plurality of predetermined locations;
recording the times at which the plurality of participants are determined to be at the plurality of predetermined locations; and
analyzing the recorded times to determine movement patterns.

13. The method for analyzing movement of a plurality of participants according to claim 12, wherein the determining step includes:
providing each of the participants with an identification device;
positioning a plurality of readers at the plurality of predetermined locations; and
determining when an identification device is near one of the plurality of readers.

14. The method for analyzing movement of a plurality of participants according to claim 13, wherein the identification device includes an RFID tag and wherein the plurality of readers includes a plurality of RFID readers.

15. The method for analyzing movement of a plurality of participants according to claim 12, further comprising the step of collecting demographic information relating to the plurality of participants, and wherein the analyzing step includes analyzing the recorded times based upon the demographic information.
